(19) United States
(12) Patent Application Publication
(10) Pub. No.: US 2011/0136029 A1
(43) Pub. Date: Jun. 9, 2011

(54) FUEL CELL AND TEMPERATURE MEASUREMENT METHOD

(75) Inventors: Jusuke Shimura, Kanagawa (JP); Yoshiaki Inoue, Aichi (JP); Kazuaki Fukushima, Kanagawa (JP); Atsushi Sato, Kanagawa (JP); Yuto Takagi, Kanagawa (JP)

(73) Assignee: SONY CORPORATION, Tokyo (JP)

(21) Appl. No.: 12/809,464

(22) PCT Filed: Dec. 17, 2008
(86) PCT No.: PCT/JP2008/072960

§ 371 Date: Jun. 18, 2010

(30) Foreign Application Priority Data
Dec. 25, 2007 (JP) P2007-332099

(51) Int. Cl. H01M 8/04

(52) U.S. Cl. 429/434

(57) ABSTRACT

A fuel cell and a temperature measurement method capable of directly measuring average temperature of a power generation unit and preventing dropout of a temperature detecting device are provided. A cathode plate for fixing the position of a power generation unit is set to be in contact with the power generation unit in a heat-transfer fashion and is made of an electric conductor or a semiconductor. When the temperature changes accompanying power generating operation of the power generation unit, the temperature of the cathode plate which is in contact with the power generation unit in a heat-transfer fashion changes. According to the temperature change, the resistance value changes. The resistance value is detected by using a resistance voltage dividing circuit having the cathode plate and resistors. By obtaining the temperature coefficient of the cathode plate in advance, the average temperature of the entire power generation unit is measured from the resistance value of the cathode plate.

### CROSS REFERENCE TO RELATED APPLICATIONS

The present application is a National Stage of International Application No. PCT/JP2008/072960 filed on Dec. 17, 2008 and which claims priority to Japanese Patent Application No. 2007-332099 filed on Dec. 25, 2007, the entire contents of which are being incorporated herein by reference.

### BACKGROUND

The present disclosure relates to a fuel cell that generates power by reaction between methanol or the like and oxygen and a temperature measurement method applied to the fuel cell.

Heretofore, since a fuel cell has high power generation efficiency and does not exhaust harmful substances, it is practically used as an industrial or household power generating device or a power source of a satellite, a space ship, or the like. Further, in recent years, development of a fuel cell as a power source for a vehicle such as passenger car, bus and truck is expanding. Such a fuel cell is classified into an alkaline fuel cell, a phosphoric acid fuel cell, a molten carbonate fuel cell, a solid oxide fuel cell, a direct methanol fuel cell, and the like. Of these types, since a direct methanol fuel cell (DMFC) realizes high energy density by using methanol as a fuel hydrogen source and miniaturization because a reformer is unnecessary, it is being studied as a small portable fuel cell.

In a DMFC, an MEA (Membrane Electrode Assembly) as a unit cell obtained by sandwiching a solid polymer electrolyte membrane by two electrodes so as to be integrally joined is used. When one of gas diffusion electrodes is set as a fuel electrode (anode) and methanol is supplied as fuel to the surface thereof, the methanol is broken down, and hydrogen ions (protons) and electrons are generated. The hydrogen ions pass through the solid polymer electrolyte membrane. When the other gas diffusion electrode is set to an oxygen electrode (cathode) and air is supplied as an oxidant to the surface thereof, oxygen in the air and the hydrogen ions and electrons are combined, and water is generated. By such an electrochemical reaction, electromotive force is generated from the DMFC.

To make such a fuel cell perform power generating operation safely, a control of monitoring the temperature of a power generation unit made by one or a plurality of unit cells, adjusting a supply amount of the fuel, and making emergency stop at the time of thermal runaway is necessary. For temperature measurement, usually, a device dedicated to detect temperature such as a thermister or a thermocouple is used. However, those devices could measure only the temperature of one point where the power generation unit exists.

Then, in the past, as a method of measuring an average value of temperatures in a plurality of places in a power generation unit, a method of connecting a plurality of thermocouples to a single temperature measuring device in series is reported (refer to, for example, patent document 1). According to the method, as compared with the case where temperature measuring device of the same number as that of thermocouples are mounted, the average temperature is obtained with a lower-cost configuration.
Patent document 1: Japanese Unexamined Patent Application Publication No. Hei 09-245824

The method descried in the patent document 1, however, has a problem such that thermocouples of the same number as that of places where temperature is sensed are necessary and further, there is the possibility of dropout of a thermocouple. In the case where a thermocouple drops due to poor attachment or the like, loss of control occurs, and there is the possibility that a very dangerous state occurs.

In view of the foregoing problems, it is desirable to provide a fuel cell in which average temperature of an entire power generation unit is measured and dropout of a temperature detecting device is prevented and a temperature measurement method.

### SUMMARY

A fuel cell of an embodiment includes: a power generation unit having a cathode and an anode; a fixing member which is in contact with the power generation unit in a heat-transfer fashion, made of an electric conductor or semiconductor, and fixes position of the power generation unit; and resistance value detecting means that detects a resistance value of the fixing member.

A temperature measurement method of an embodiment is a method for measuring temperature of a power generation unit in a fuel cell including the power generation unit having a cathode and an anode. A fixing member that fixes position of the power generation unit is connected to the power generation unit in a heat-transfer fashion, made of an electric conductor or semiconductor, and detects a resistance value of the fixing member.

In the fuel cell and the temperature measurement method of the embodiments, when the temperature of the power generation unit changes, the temperature of the fixing member connected to the power generation unit in a heat-transfer fashion changes accordingly. At this time, according to the temperature change, the resistance value of the fixing member changes, and is detected by the resistance value detecting means.

According to the fuel cell of the embodiment or the temperature measurement method of the embodiment, the fixing member that fixes the position of the power generation unit is connected to the power generation unit in a heat-transfer fashion and is made of the electric conductor or semiconductor, and the resistance value of the fixing member is detected by the resistance value detecting means. Therefore, the average temperature of the entire power generation unit, not local temperature of a part of the power generation unit can be measured. In addition, a device dedicated to detect temperature such as a thermocouple or thermister is made unnecessary, and the fixing member can be used as a temperature detecting device. Thus, the possibility that loss of control occurs due to dropout of the temperature detecting device can be considerably reduced.

Additional features and advantages are described herein, and will be apparent from, the following Detailed Description and the figures.

### BRIEF DESCRIPTION OF THE FIGURES

FIG. 1 is an exploded perspective view illustrating a whole configuration of a fuel cell according to an embodiment.

FIG. 2 is perspective views illustrating the configuration of a cathode plate shown in FIG. 1.

FIG. 3 is a cross section illustrating the configuration of a power generation unit shown in FIG. 1.

FIG. 4 is a plan view illustrating the configuration of the power generation unit shown in FIG. 1.

FIG. 5 is a cross section for explaining a method of manufacturing the power generation unit illustrated in FIG. 1.

FIG. 6 is a cross section for explaining the method of manufacturing the power generation unit illustrated in FIG. 1.

FIG. 7 is a diagram illustrating a modification of FIG. 2.

FIG. 8 is a graph illustrating a result of the example.

### DETAILED DESCRIPTION

An embodiment will be described in detail below with reference to the drawings.

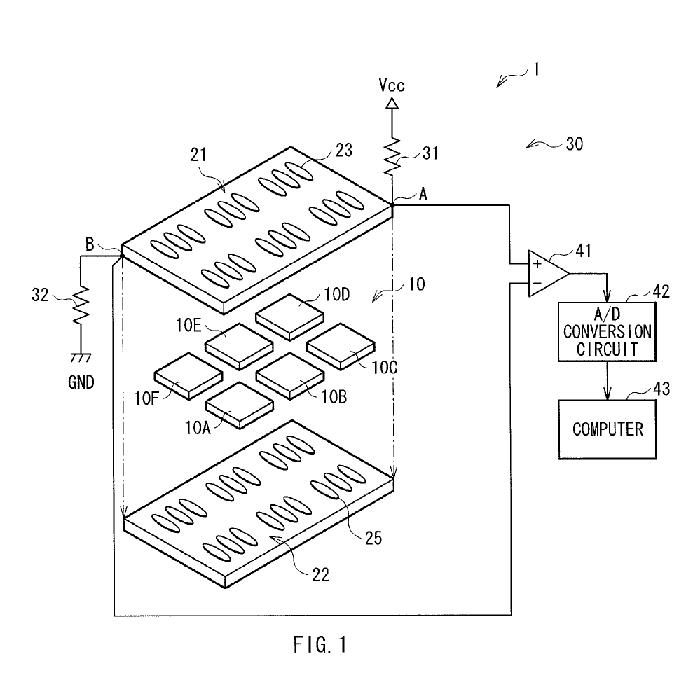

FIG. 1 illustrates a whole configuration of a fuel cell according to an embodiment. A fuel cell 1 is used as, for example, a power source of a cellular phone or a portable electronic device such as a notebook-type PC (Personal Computer), and has a power generation unit 10 and a cathode plate 21 and an anode plate 22 fixing the position of the power generation unit 10.

The power generation unit 10 is a power generation unit of a direct methanol type that generates power by a reaction between methanol and oxygen, and includes one or plural (in FIG. 1, for example, six) unit cells 10A to 10F each having a cathode (oxygen electrode) and an anode (fuel electrode).

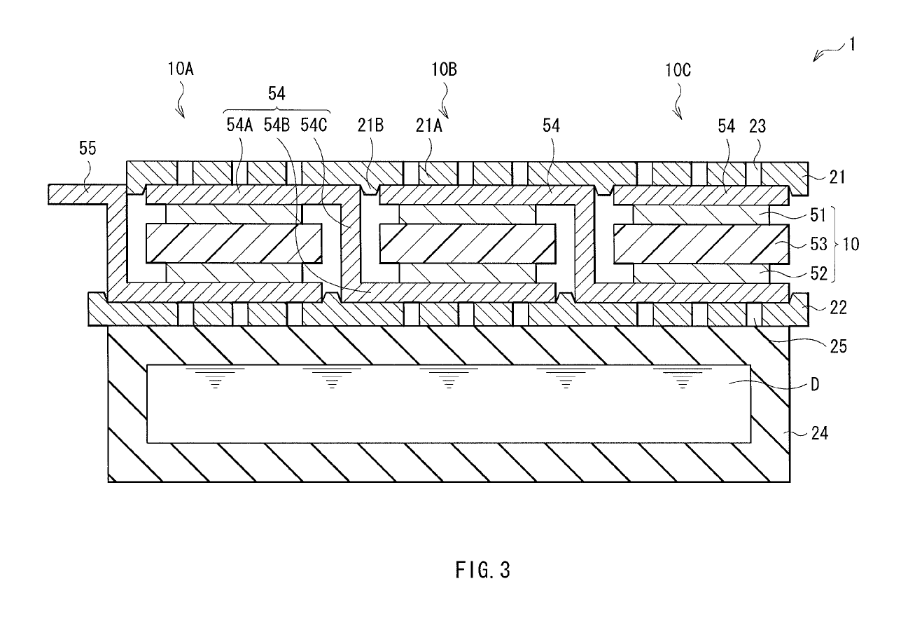

The cathode plate 21 and the anode plate 22 have the function as a fixing member of fixing the positions of the cathode and the anode in the power generation unit 10, respectively and are made by, for example, aluminum plates each having a thickness of about 1 mm. The cathode plate 21 is provided with through holes 23 for passing air (oxygen) as an oxidant. Below the anode plate 22, a fuel tank 24 (not shown in FIG. 1, refer to FIG. 3) containing, for example, methanol as a fuel F is provided. The methanol is supplied in a pulsation fashion (intermittently) from the fuel tank. Methanol is supplied in a vaporized state to the anodes of the unit cells 10A to 10F via the through holes 25 in the anode plate 22. Methanol may be supplied in a liquid state.

In the case where the power generation unit 10 has the plurality of unit cells 10A to 10F, the cathode plate 21 and the anode plate 22 are electrically insulated from the power generation unit 10 to prevent short circuit. Concretely, each of the cathode plate 21 and the anode plate 22 has, in at least a part of the surface (for example, a part which is in contact with the power generation unit 10), for example, an insulating film (not shown) made of aluminum oxide formed by alumite treatment. The insulating film may be an oxide film or a polymer film.

The cathode plate 21 covers all of the unit anodes of the cells 10A to 10F in the power generation unit 10 and is in contact with the power generation unit 10 so as to transfer heat. With the configuration, the temperature of the cathode plate 21 becomes average temperature of all of the unit cells 10A to 10F of the power generation unit. In addition, the cathode plate 21 is made of an electric conductor or a semiconductor and the resistance value changes according to temperature, that is, the cathode plate 21 has a temperature coefficient. By the cathode plate 21 and resistors 31 and 32, a resistance voltage dividing circuit 30 is constructed. The resistor 31 is connected between a point A in the cathode plate 21 and a voltage source Vcc (for example, 3.3V). The resistor 32 is connected between a point B in the cathode plate 21 and a ground GND (0V). The positions of the points A and B are not limited but, for example, are preferably two points on a diagonal line of the cathode plate 21 for a reason that the temperature of the positive plat 21 is measured in a wider range.

As resistance value detecting means that detects a resistance value of the cathode plate 21 by using such a resistance voltage diving circuit 30, a differential amplifier 41 amplifying the potential difference between the points A and B, an A/D conversion circuit 42 that A/D (analog to digital) converts output voltage (analog voltage) from the differential amplifier 41, and a computer 43 that calculates a resistance value of the cathode plate 21 on the basis of output voltage (digital voltage) from the A/D conversion circuit 42. With the configuration, in the fuel cell 1, the average temperature of the entire power generation unit 10 can be measured, and dropout of a temperature detection element can be prevented.

Examples of a preferred electric conductor constructing the cathode plate 21 include not only the above-described aluminum but also magnesium, nickel, platinum, rhodium, and cobalt, and a compound containing any of them. This is because since magnesium has the highest temperature coefficient among metals generally used, and nickel has the second highest temperature coefficient, with the metals, the S/N ratio (signal to noise ratio) can be increased. Further, this is because the platinum, rhodium, and cobalt are metals used for a thermocouple and similarly have a high temperature coefficient.

Examples of a preferred semiconductor constructing the cathode plate 21 include ferrosoferric oxide, manganese chromate, magnesium aluminate, nickel oxide (II), dimanganese trioxide, chromic oxide (III), and compounds containing any of them. This is because they are semiconductors constructing a thermister and have a high temperature coefficient.

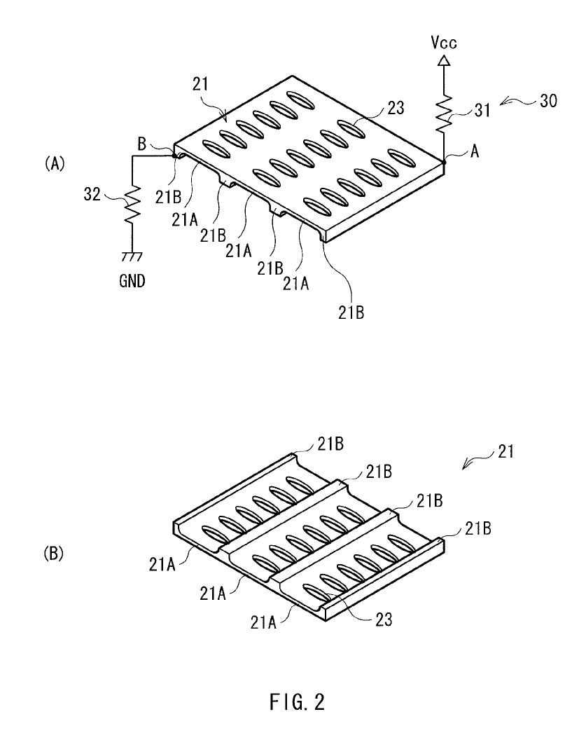

FIG. 2 illustrates a detailed configuration of the cathode plate 21. In the cathode plate 21, thermosensitive parts 21A which are in contact with the unit cells 10A to 10F in the power generation unit 10 are thinner than the other non-thermosensitive parts 21B. That is, in a sectional shape of the cathode plate 21, the sectional area of the thermosensitive parts 21A is smaller than that of the non-thermosensitive parts 21B. Therefore, the non-thermosensitive parts 21B have a large sectional area, low resistance, and a small resistance temperature change. In contrast, the thermosensitive parts 21A have a small sectional area, high resistance, a large resistance temperature change, and improved responsiveness to temperature. In such a manner, in the cathode plate 21, parts having high temperature sensitive capability and parts having low temperature sensitive capability are freely formed as structures of the thermosensitive parts 21A and the non-thermosensitive parts 21B.

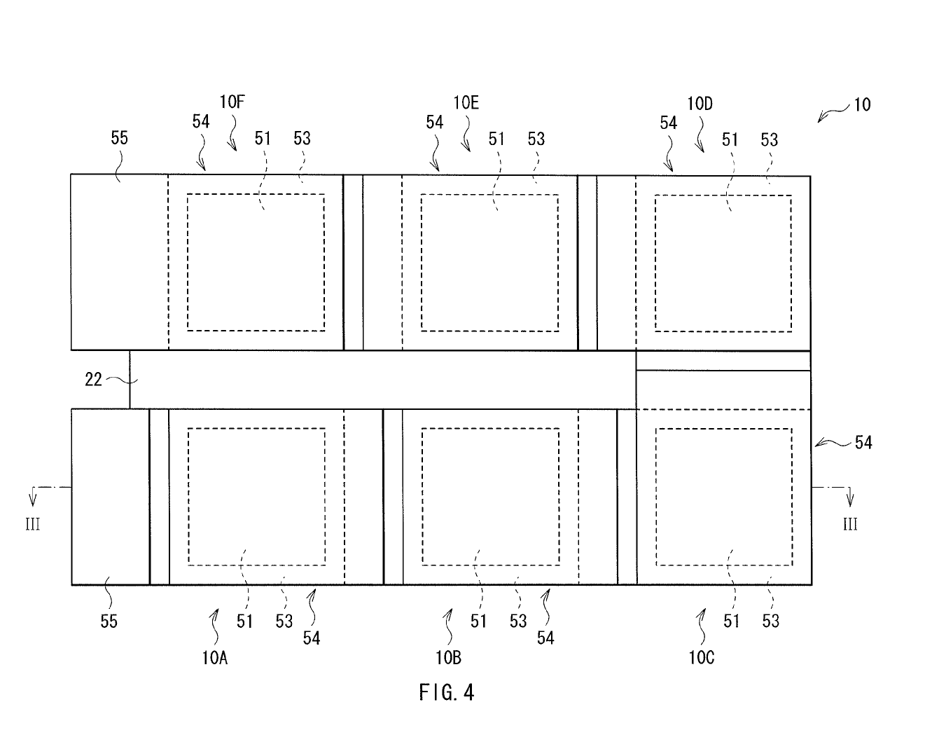

FIGS. 3 and 4 illustrate a configuration example of the unit cells 10A to 10F in the power generation unit 10. FIG. 3 corresponds to a cross section taken along line III-III in FIG. 4. Each of the unit cells 10A to 10F has an electrolyte film 53 between a cathode (oxygen electrode) 51 and an anode (fuel electrode) 52. The unit cells 10A to 10F have a plane stack structure that arranged in, for example, three rows by two columns in the in-plane direction and are electrically connected in series by a plurality of connection members 54. To the unit cells 10A and 10F, terminals 55 as extension parts of the connection members 54 are attached.

Each of the cathode 51 and the anode 52 has a configuration in which, for example, a catalyst layer containing catalyst such as platinum (Pt) and ruthenium (Ru) is formed in a current collector made of carbon paper or the like. The catalyst layer is constructed by, for example, dispersing a supporting member such as catalyst-supported carbon black in a polyperfuluoroalkyl sulfonic acid-based proton conducting material or the like. In addition, a not-shown air supply pump may be connected to the cathode 51. The cathode 51 may be communicated with the outside via an opening (not shown) formed in the connection member 54 so that oxygen in air is supplied by natural ventilation.

The electrolyte film 53 is made of, for example, a proton conducting material having a sulfonate group (—SO3H). Examples of the proton conducting material include a polyperfuluoroalkyl sulfonic acid-based proton conducting material (for example, “Nafion” (registered trademark) made by DuPont), a hydrocarbon-based proton conducting material such as polyimide sulfonic acid, and a fullerene-based proton conducting material.

The connection member 54 has a bent part 54C between two flat parts 54A and 54B, is in contact with the anode 52 of one unit cell (for example, 10A) in the flat part 54A, and is in contact with the cathode 51 of the neighboring unit cell (for example, 10B) in the other flat part 54B. The connection member 54 electrically connects neighboring two unit cells (for example, 10A and 10B) and also has the function as a current collector of collecting electricity generated in each of the unit cells 10A to 10F. For example, such a connection member 54 has a thickness of 150 μm and is made of copper (Cu), nickel (Ni), titanium (Ti), or stainless steel (SUS), or may be plated with gold (Au), platinum (Pt), or the like. Further, the connection member 54 has an opening (not shown) for supplying air and the fuel F to the cathode 51 and the anode 52 and is constructed by, for example, meshes such as expanded metal, punching metal, or the like. The bent part 54C may be preliminarily bent in accordance with the thickness of the unit cells 10A to 10F. In the case where the connection member 54 is made of mesh having a thickness of 200 μm or less and has flexibility, the bent part 54C may be formed by being bent in a manufacturing process. Such a connection member 54 is joined to the unit cells 10A to 10F by, for example, screwing a sealing member (not shown) such as PPS (polyphenylene sulfide), silicone rubber, or the like provided in the periphery of the electrolyte film 53 to the connection member 54.

For example, the fuel cell 1 can be manufactured as follows.

First, the electrolyte film 53 made of the above-described material is sandwiched between the cathode 51 and the anode 52 made of the above-described materials and joined by thermal compression bonding, and the unit cells 10A to 10F are formed.

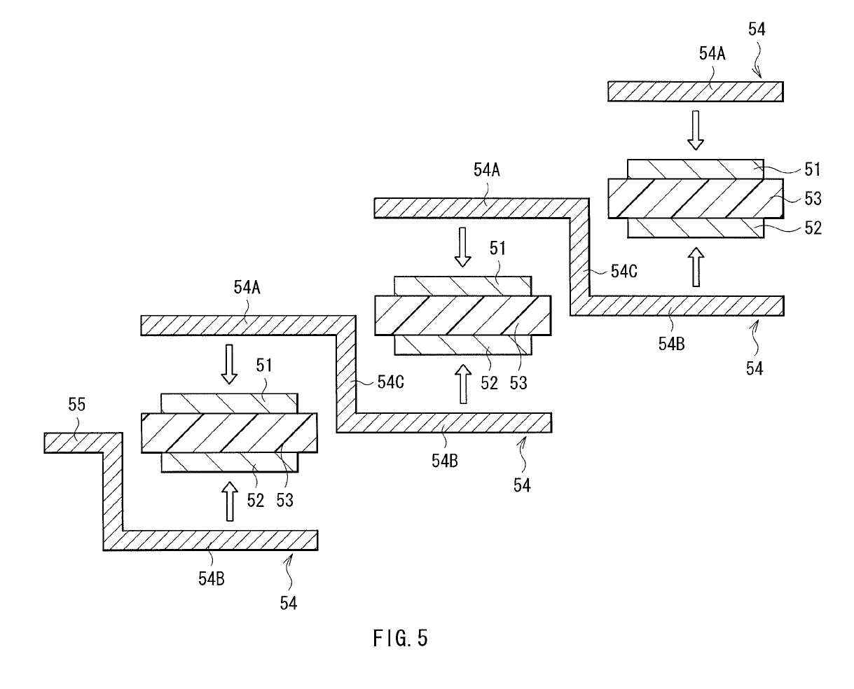

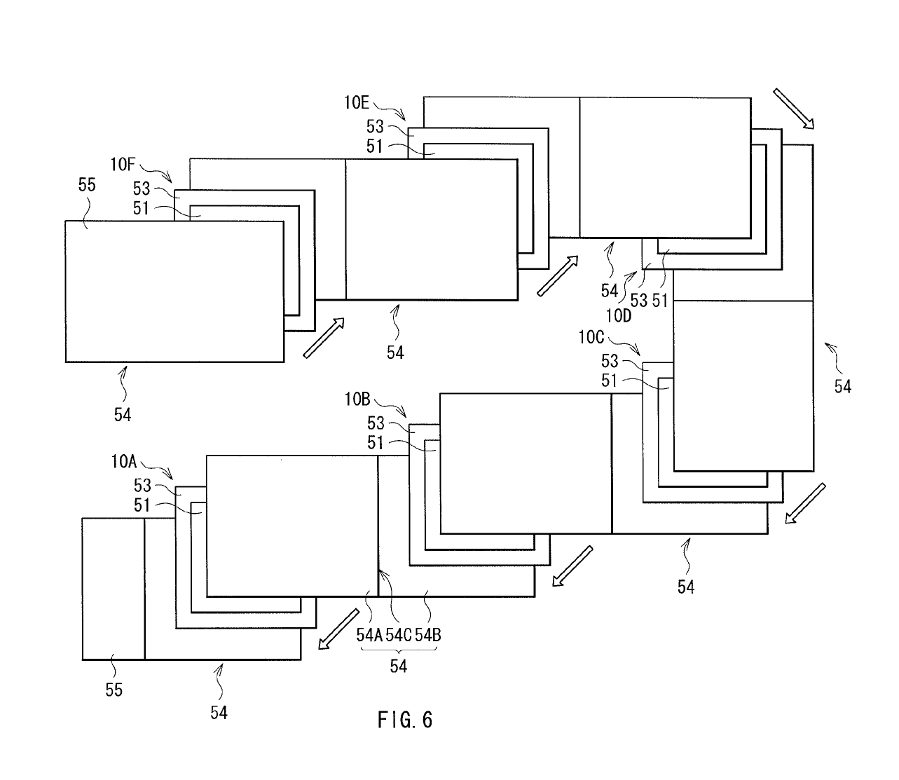

Subsequently, the connection member 54 made of the above-described material is prepared. As shown in FIGS. 5 and 6, six unit cells 10A to 10F are arranged in three rows by two columns and are electrically connected in series by the connection members 54. The sealing member (not shown) made of the above-described material is provided in the periphery of the electrolyte film 53 and is fixed to the bent part 54C in the connection member 54 by screwing.

Subsequently, the cathode plate 21 and the anode plate 22 made of the above-described materials are prepared. By oxide film treatment (for example, alumite treatment), polymer film treatment, or the like, an insulating film is formed in at least a part of the surface. For example, by using a file, the insulating film in the surface at points A and B in the cathode plate 21 is eliminated. The resistors 31 and 32 are connected to the points A and B, respectively, thereby constructing the resistance voltage dividing circuit 30.

After that, the anode plate 21 is disposed on the cathode 51 side of the coupled unit cells 10A to 10F, and the anode plate 22 and the fuel tank 24 are disposed on the anode 52 side. Further, to the points A and B in the cathode plate 21, the differential amplifier 41, the A/D conversion circuit 42, and the computer 43 are connected. As a result, the fuel cell 1 illustrated in FIGS. 1 to 4 is completed.

In the fuel cell 1, the fuel F is supplied to the anode 52 in each of the unit cells 10A to 10F and protons and electrons are generated by reaction. The protons move to the cathode 51 via the electrolyte film 53 and react with the electrons and oxygen to generate water. By the reaction, a part of the chemical energy of the fuel F, that is, methanol is converted to electric energy. The electric energy is collected by the connection member 54 and taken as output current from the power generation unit 10. The output current and the electromotive force generated by the power generation unit 10 are supplied to a load (not shown) on the outside, and the load is driven.

When the temperature of the power generation unit 10 changes with the power generating operation, the temperature of the cathode plate 21 which is in contact with the power generation unit 10 in a heat-transfer fashion changes. According to the temperature change, the resistance value changes and is detected by using the resistance voltage dividing circuit 30. Therefore, when the temperature coefficient of the cathode plate 21 is obtained in advance, the average temperature of the entire power generation unit 10 is measured from the resistance value of the cathode plate 21. On the basis of the temperature of the power generation unit 10 measured as above, the supply of the fuel F is adjusted, and the temperature of the power generation unit 10 is controlled so as not to increase needlessly.

Further, at the time of measuring the average temperature of the power generation unit 10, it is unnecessary to use a device dedicated to temperature detection such as a thermocouple or thermister unlike the related art, and the cathode plate 21 may be used as a temperature detecting device. Therefore, the possibility that loss of control caused by dropout of the temperature detecting device does not occur.

In the embodiment as described above, the cathode plate 21 fixing the position of the power generation unit 10 is connected to the power generation unit 10 in a heat-transfer fashion and is made of an electric conductor or a semiconductor, and the resistance value of the cathode plate 21 is detected by using the resistance voltage dividing circuit 30. Thus, average temperature of the entire power generation unit 10, not local temperature of a part of the power generation unit 10 can be measured. In addition, a device dedicated to detect temperature such as a thermocouple or thermister is made unnecessary, and the temperature of the power generation unit 10 is measured by using the cathode plate 21 as a temperature detecting device. Thus, the possibility that loss of control occurs due to dropout of the temperature detecting device is considerably reduced, assembly is facilitated, and cost can be lowered.

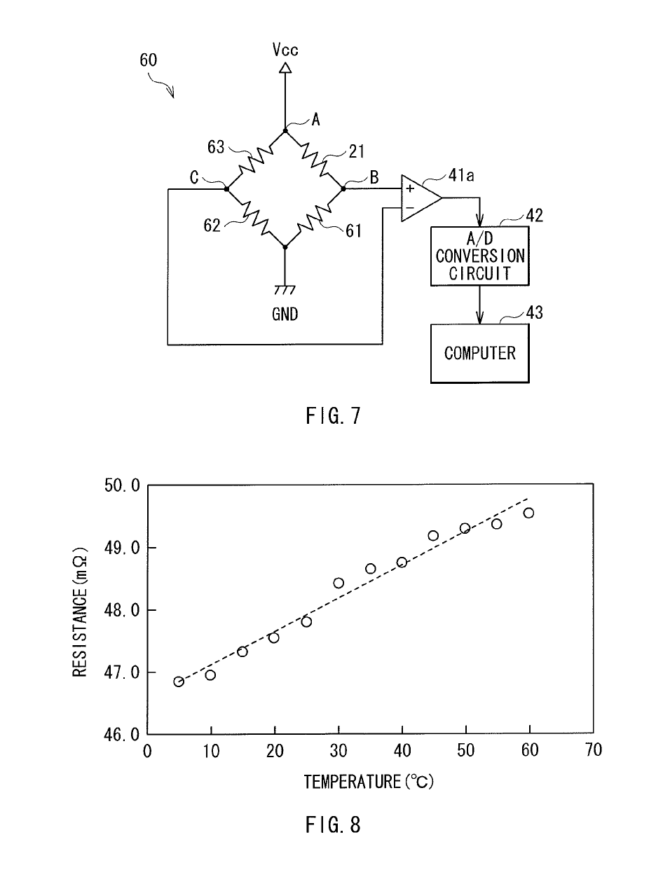

In addition, in place of the resistance voltage dividing circuit 30, for example, as shown in FIG. 7, a resistance bridge circuit 60 having the cathode plate 21 and resistors 61, 62, and 63 may be provided. Concretely, the point A in the cathode plate 21 is connected to one end of the resistor 63 and the voltage source Vcc, the point B in the cathode plate 21 is connected to one end of the resistor 61, the other end of the resistor 63 and one end of the resistor 62 are mutually connected to the point C, and the other points of the resistors 61 and 62 are mutually connected to the ground GND. Further, as resistance value detecting means for detecting the resistance value of the cathode plate 21 by using such a resistance bridge circuit 60, a differential amplifier 41a for amplifying the potential difference between the points B and C, the A/D conversion circuit 42 for A/D converting output voltage (analog voltage) from the differential amplifier 41a, and the computer 43 for calculating the resistance value of the cathode plate 21 on the basis of output voltage (digital voltage) from the A/D conversion circuit 42 are provided. Also in the fuel cell 1 having such a configuration, when the temperature of the power generation unit 10 changes, the temperature of the cathode plate 21 which is in contact with the power generation unit 10 in a heat-transfer fashion changes and, according to the temperature change, the resistance value changes. The resistance value is detected by the resistance bridge circuit 60. Therefore, by the operation similar to that of the embodiment, similar effects are obtained.

### Example

Further, a concrete example of the present invention will be described.

The cathode plate 21 illustrated in FIG. 1 was manufactured. First, the two points A and B at opposing corners of the cathode plate 21 (external dimensions: 35 mm×50 mm×1 mm) made of aluminum which was subjected to the alumite treatment were filed to remove the alumite film on the surface. Subsequently, the resistors 31 and 32 of 180Ω were prepared and the resistor 31, the cathode plate 21, and the resistor 32 were connected in order in series, thereby constructing the resistance voltage dividing circuit 30. The resistor 31 connected the voltage source Vcc (3.3V) and the point A, and the resistor 32 connected the point B and the ground GND (0V).

The temperature of the cathode plate 21 obtained was changed by 5 C.° from 0 C.° to 60° C. and the resistance value and voltage between A and B were measured. The result is illustrated in FIG. 8 and Table 1. When a formula of a linear regression line was calculated by using the least-square method, the temperature coefficients of 53.2 μΩ/° C. and 487 μΩV/° C. were obtained for the resistance value and the voltage, respectively.

TABLE 1

| | A-B resistance | A-B voltage |
|---|---|---|
| Temperature (° C.) | (mΩ) | (mV) |
| 5 | 46.8 | 429 |
| 10 | 47.0 | 430 |
| 15 | 47.3 | 434 |
| 20 | 47.6 | 436 |
| 25 | 47.8 | 438 |
| 30 | 48.4 | 444 |
| 35 | 48.7 | 446 |
| 40 | 48.8 | 447 |
| 45 | 49.2 | 451 |
| 50 | 49.3 | 452 |
| 55 | 49.4 | 452 |
| 60 | 49.5 | 454 |

The values of the temperature coefficients are values which are sufficiently measured by an inexpensive A/D conversion circuit, and it was confirmed that the cathode plate 21 sufficiently functioned as a temperature detecting device. That is, it was found out that by making the cathode plate 21 fixing the position of the power generation unit 10 of aluminum and detecting the resistance value of the cathode plate 21 by the resistance voltage dividing circuit 30, the average temperature of the entire power generation unit 10 could be measured.

Although the case of measuring the resistance value of the cathode plate 21 has been described in the foregoing embodiment and the example, the resistance value of the anode plate 22 may be measured. However, in the case of vaporizing the fuel F in the DMFC and supplying the vaporized fuel F, heat is lost at the time of vaporization of the fuel F. There is consequently the possibility that the temperature measurement result of the power generation unit 10 becomes lower than actual temperature. Further, in the case of supplying the fuel F intermittently (in a pulsation fashion), there is the possibility that the temperature measurement result also fluctuates accordingly. Thus, by measuring the resistance value of the cathode plate 21, the temperature which is not influenced by vaporization heat can be measured.

Further, in the foregoing embodiment and the example, the case of measuring the resistance value of the cathode plate 21 by using the resistance voltage dividing circuit 30 or the resistance bridge circuit 60 has been described. However, the circuit for measuring the resistance value of the cathode plate 21 is not limited to those circuits.

Further, although the configuration of the power generation unit 10 has been concretely described in the foregoing embodiment, the power generation unit 10 may be constructed by another structure or another material.

In addition, for example, the materials and thickness of the components described in the foregoing embodiment and the example, the power generation conditions of the power generation unit 10 and the like are not limited. Other materials and thicknesses and other power generation conditions may be employed.

Furthermore, for example, the liquid fuel is not limited to methanol but may be another fuel such as ethanol or dimethyl ether.

In addition, although air is supplied to the cathode 51 by natural ventilation in the foregoing embodiment and example, air may be forcedly supplied by using a pump or the like. In this case, oxygen or gas containing oxygen may be supplied in place of air.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-9. (canceled)

10. A fuel cell comprising:
a power generation unit having a cathode and an anode;
a fixing member which is in contact with the power generation unit in a heat-transfer fashion, the fixing member made of an electric conductor or a semiconductor, and that fixes a position of the power generation unit; and
resistance value detecting means that detects a resistance value of the fixing member.

11. The fuel cell according to claim 10, wherein the fixing member has a thermosensitive part which is in contact with the power generation unit and a non-thermosensitive part other than the thermosensitive part, and
sectional area of the thermosensitive part is smaller than that of the non-thermosensitive part in a sectional shape of the fixing member.

12. The fuel cell according to claim 10, wherein the resistance value detecting means detects the resistance value of the fixing member by using a resistance voltage dividing circuit including the fixing member.

13. The fuel cell according to claim 10, wherein the resistance value detecting means detects the resistance value of the fixing member by using a resistance bridge circuit including the fixing member.

14. The fuel cell according to claim 10, wherein the fixing member fixes position of the cathode of the power generation unit.

15. The fuel cell according to claim 10, wherein the fixing member fixes position of the anode of the power generation unit.

16. The fuel cell according to claim 10, wherein the power generation unit has a plurality of unit cells, and the fixing member is electrically insulated from the power generation unit.

17. The fuel cell according to claim 16, wherein the fixing member is made of aluminum and has a film made of aluminum oxide in at least a part of the surface.

18. A temperature measurement method comprising:
measuring a temperature of a power generation unit having a cathode and an anode, in a fuel cell including the power generation unit,
wherein a fixing member that fixes a position of the power generation unit is connected to the power generation unit in a heat-transfer fashion and is made of an electric conductor or a semiconductor, and a resistance value of the fixing member is detected.
